(19) United States
(12) Patent Application Publication
(10) Pub. No.: US 2005/0102700 A1
(43) Pub. Date: May 12, 2005

(54) Automatic program restoration when a programming break ends

(76) Inventors: Christopher J. Cormack, Hillsboro, OR (US); Tony Moy, Beaverton, OR (US)

Correspondence Address: Alan Pedersen-Giles;BLAKELY, SOKOLOFF, TAYLOR & ZAFMAN LLP, Seventh Floor, 12400 Wilshire Boulevard, Los Angeles, CA, 90025-1030, US

(21) Appl. No.: 10/703,319

(22) Filed: Nov. 7, 2003

(51) Int. Cl. H04N 7/173; H04N 7/16

(52) U.S. Cl. 725/100; 725/131; 725/151; 725/139; 348/731; 725/134

(57) ABSTRACT

A method of program restoration may include outputting a first stream of media information until a triggering event and outputting a second stream of media information after the triggering event. The method may include monitoring the first stream of media information for one or more characteristics that reflect a change in the first stream of media information. The second stream of media information may be ceased and the first stream of media information may be output upon detection of the one or more characteristics of the first stream of media information.

### BACKGROUND

The claimed invention relates to media devices and, more particularly, to information handling by media devices.

Media devices have been proposed to communicate with a source/conduit of media information (e.g., a communication channel) and to connect to one or more peripheral devices (e.g., televisions, communication devices, etc.) for which the media information is destined. Media devices may be used to receive media information and route the information to one or more connected peripheral devices. Control devices (e.g., remote controls) associated with the peripheral devices may provide input to the media device to assist in routing desired media information (e.g., television channels) to particular peripheral devices.

Some media devices may include storage to record incoming media information for playback at a later time. Although capable of handling basic recording and playback functions, such media devices may lack the ability to exploit the recorded media information in other ways that may be desirable to users of the devices.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. In the drawings,

FIG. 1 illustrates an example system consistent with the principles of the invention;

FIG. 2 is a flow chart illustrating a process of interruption and resumption of media information consistent with the principles of the invention.

### DETAILED DESCRIPTION

The following detailed description refers to the accompanying drawings. The same reference numbers may be used in different drawings to identify the same or similar elements. Also, the following detailed description illustrates certain implementations and principles, but the scope of the claimed invention is defined by the appended claims and equivalents.

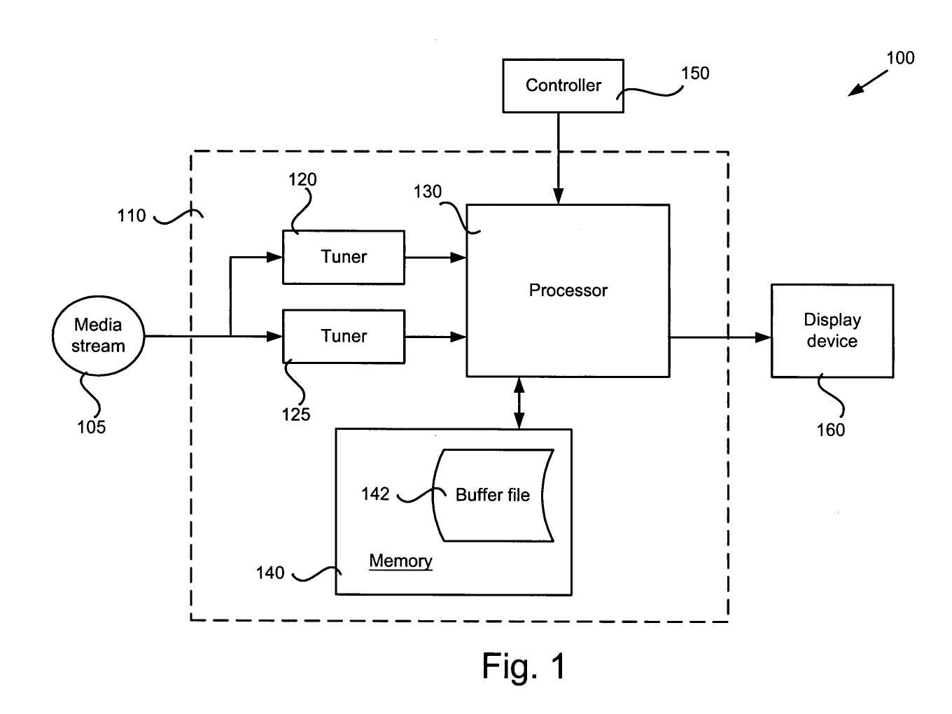

FIG. 1 illustrates an example system 100 consistent with the principles of the invention. System 100 may include a media stream 105, a media device 110, a controller 150, and a display device 160. Media stream 105, controller 150, and display device 160 may all be arranged to interface with media device 110.

Media stream 105 may arrive from a source of media information via a wireless or wired communication link to media device 110. Media stream 105 may include one or more individual streams (e.g., channels) of media information. Sources of media streams 105 may include cable, satellite, or broadcast television providers. Media stream 105 may also originate from a device, such as a video camera, playback device, a video game console, a remote device across a network (e.g., the Internet), or any other source of media information.

Media device 110 may receive media information from media stream 105 and may output the same or different media information to display device 160 under the control of controller 150. Some examples of media devices 110 may include personal video recorders (PVRs), media centers, set-top boxes, and/or general-purpose or special-purpose computing devices.

FIG. 1 also illustrates an example implementation of media device 110 in system 100 consistent with the principles of the invention. Media device 110 may include a first tuner 120, a second tuner 125, a processor 130, and a memory 140. Although media device 110 may include some or all of elements 120-140, it may also include other elements that are not illustrated for clarity of explanation. Further, elements 120-140 may be implemented by hardware, software/firmware, or some combination thereof, and although illustrated as separate functional modules for ease of explanation, elements 120-140 may not be implemented as discrete elements within media device 110.

First tuner 120 may include one or more devices arranged to separate one or more streams of information from media stream 105. First tuner 120 may lock onto and output a first stream of information, such as a television channel or other information, present at a first frequency range in media stream 105. The particular choice of which first stream or channel to be output by first tuner 120 may be made by a user of controller 150 and sent to first tuner 120 via processor 130.

Second tuner 125 also may include one or more devices arranged to separate one or more streams of information from media stream 105. Second tuner 125 may lock onto and output a second stream of information, such as a television channel or other information, present at a second frequency range in media stream 105. The second stream or channel output by second tuner 125 may be determined by controller 150 independently from the first stream or channel output by first tuner 120. Thus, at any time processor 130 may receive two different streams or channels of information that are present in media stream 105.

Processor 130 may interact with memory 140 to process at least one of first and second streams of information from tuners 120 and 125. Processor 130 may also interact with controller 150 to display media information from memory 140 and/or one or more of tuners 120 and 125. Further details of processor 130's interoperation with these other elements of media device 110 will be subsequently provided. Processor 130 may primarily control writing of information to memory 140 and reading of information from memory 140.

In addition, processor 130 may also perform other associated tasks, such as encoding or decoding of media information before and/or after storage in memory 140. For example, processor 130 may convert media information to or from various formats, such as MPEG-1, MPEG-2, MPEG-4 (from the Moving Picture Experts Group), or any other known or later-developed format. Processor 130 may also control which channels of information in media stream 105 are selected by first and second tuners 120 and 125.

Processor 130 may operate in at least two modes: a normal mode and a monitoring mode. In the normal mode, processor 130 may store media information from first tuner 120 to memory 140, with or without encoding it first. Optionally, processor 130 may pass the media information through to display device 160. In some implementations, processor 130 may read media information to be displayed from memory 140 using a read pointer to the stored media information, rather than passing through media information from tuner 120. Such display of media information from memory 140 allows time-shifting of information from first tuner 120, and facilitates playback functions such as pausing, fast-forwarding, and rewinding the media information from memory 140 via the read pointer.

In the monitoring mode, processor 130 may continue to store information from first tuner 120 to memory 140, but may send media information from second tuner 125 on display device 160. While storing the media information from first tuner 120, processor 130 may monitor such stored information for a predetermined condition, and upon the occurrence of such condition processor 130 may perform an action, such as returning to the normal mode of operation. As one example, processor 130 may enter monitoring mode when a commercial or other undesired content appears in the media information from first tuner 120. Information from second tuner 125 may then be viewed until the commercial from first tuner 120 ends. Upon observance of that condition, processor 130 may automatically return to the normal mode of viewing information from first tuner 120, as will be described in greater detail below.

Memory 140 may include at least a buffer file 142. Memory 140 may include a solid-state, magnetic or optical storage medium, examples of which may include semiconductor-based memory, hard disks, optical disks, etc. Though memory 140 is only illustrated as connected to processor 130 in FIG. 1, in practice memory 140 also may be connected to one or both of tuners 120 and 125 to facilitate recording or playback of media information.

Buffer file 142 may include media information from first tuner 120 and/or second tuner 125 that is stored by processor 130. Buffer file 142 may be implemented as a fixed-size buffer or circular file that loops back to its beginning when its end is reached to reduce the possibility of filling up memory 140 with media information. Buffer file 142 may include a time-continuous stream of media information or several discontinuous streams. In the normal mode, processor 130 may read media information from any portion of buffer file 142 using one or more read pointers or similar placeholders to play desired media.

Controller 150 may communicate with media device 110 via a wireless or wired communication link. Controller 150 may include a remote control arranged to control playback of video data via processor 130 and to control display of the video data on display device 160. In addition to controlling the playback during the normal playback mode (e.g., by pausing, rewinding, etc.), controller 150 may also initiate and/or terminate the monitoring. For example, a user may begin the monitoring mode by pressing a “return to show” button after a commercial begins in the media information from first tuner 120.

Display device 160 may include a television, monitor, projector, or other device suitable for displaying media information, such as video and audio. Display device 160 may utilize a number of technologies for such displaying, including cathode ray tube (CRT), liquid crystal display (LCD), plasma, and/or projection-type technologies. In some implementations, display device 160 may be located proximate media device 110, which may in some implementations sit on top of or adjacent to the display. In other implementations consistent with the principles of the invention, display device 160 may be located remote from media device 110.

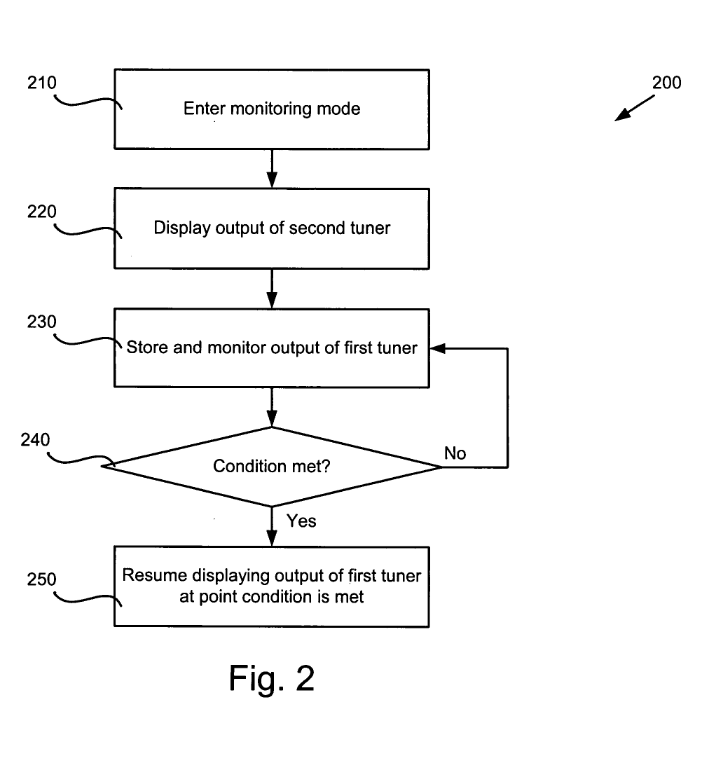

FIG. 2 is a flow chart illustrating a process 200 of interruption and resumption of media information consistent with the principles of the invention. Processing may begin with processor 130 entering a monitoring mode [act 210]. Immediately prior to act 210, processor 130 may have been in a normal mode, storing media information from first tuner 120 to memory 140 and displaying the media information from buffer file 142 based on a read pointer to a current location in buffer file 142.

Processor 130 may enter the monitoring mode in act 210 in response to a user-driven event, such as button-push on controller 150. For example, the user may push a “return to show” button on controller 150 to initiate the monitoring mode. In other implementations consistent with the principles of the invention, monitoring mode may be automatically entered in act 210. For example, processor 130's default behavior may be to enter monitoring mode whenever processor 130 senses a commercial break or other undesired programming in the media information from first tuner 120. Further, processor 130 may optionally display an indication, such as a graphical overlay, on display device 160 that monitoring mode has been entered.

Processing may continue with processor 130 sending the output of second tuner 125 to display device 160 [act 220]. Processor 130 may initialize the output of second tuner 125 to a certain channel, such as the channel that first tuner 120 is outputting, or second tuner 125 may not be initialized. In such an instance, second tuner 125 may output whatever channel it was last adjusted to, for example, in a prior monitoring mode. While processor 130 is in monitoring mode, any channel change commands from controller 150 may affect second tuner 125, whose output is being passed to display device 160.

By passing the output of second tuner 125 to display device 160, a user may watch a channel other than the one output from first tuner 120 that is being monitored. The channel output by second tuner 125 may be changed as often as desired by controller 150. Further, the channel output by second tuner 125 may be the same as the monitored channel output by first tuner 120 if the user desires to watch the commercial or other programming (e.g., halftime show) on the monitored channel.

In the monitoring mode, processor 130 may continue to store and monitor the media information on the monitored channel from first tuner 120 to memory 140 [act 230]. In conjunction with act 230, processor 130 may also freeze or stop incrementing the read pointer to buffer file 142 at the point at which the monitoring mode was entered. Processor 130 may monitor the stored media information for a desired condition, such as the end of commercial programming on the channel output by first tuner 120. Processor 130 may monitor the media information for the desired condition using one or more of a number of techniques.

Processor 130 may monitor the media information for one or more of: a video break, a change in resolution, a change in volume, a change in color, and/or an elapsed time. For example, a black video frame may be inserted by broadcasters into the media information before the first commercial in a series and after the last commercial in a series. Processor 130 may exploit this black frame, or a similar mechanism that may be intended to aid local stations in finding and inserting local commercials, to determine the end of a string of commercials. Alternately or additionally, processor 130 may detect a change in video resolution or definition. For example, commercials may be in standard definition, while non-commercial programming may be in a higher definition mode. Processor 130 may detect such a change in resolution.

Alternately or additionally, processor 130 may monitor and examine the audio volume of the stored media information from first tuner 120. Processor 130 may differentiate between commercial and non-commercial programming based on an observation that commercials tend to be louder than non-commercial programming. Hence, processor 130 may at least partially base its detection of the end of a commercial on a lower average volume. Alternately or additionally, processor 130 may examine the video stream, using colors and scenes to determine if it's the program or a commercial. Alternately or additionally, processor 130 may monitor how much time has elapsed since entering monitoring mode. Processor 130 may algorithmically exploit the convention that commercials tend to be in 15 or 30 second blocks. Processor 130 may use two or more of the above techniques to detect a desired condition (e.g., the end of a commercial or series of commercials) with a desired level of confidence.

At certain times, processor 130 may determine whether the desired condition of the media information from first tuner 120 has been met [act 240]. If the condition has not occurred, processor 130 may continue to store and monitor media information from first tuner 120 in act 230.

If processor 130 determines that the condition of the monitored media information has been met in act 240, it may discontinue displaying media information from second tuner 125 and may resume displaying information from first tuner 120 via buffer file 142 [act 250]. The read pointer, which may have been frozen/stopped in act 210, may be set to the point at which the condition was met in act 240 (e.g., beyond the commercials or other undesired programming). Output of the media information from first tuner 120 may continue from this point.

After act 250, the monitoring mode may end in some implementations. In other words, the monitoring mode may only persist until the end of the commercials or other undesired programming. In other implementations, however, the monitoring mode may persist when conditions are appropriate. For example, processor 130 may monitor the media information from first tuner 120 when it is displayed for the start of a commercial or other undesired programming. Such monitoring may involve complementary conditions to those used in act 230. If the start of a commercial or other undesired programming is detected, the monitoring mode may resume at act 210.

The foregoing description of one or more implementations consistent with the principles of the invention provides illustration and description, but is not intended to be exhaustive or to limit the claimed invention to the precise form disclosed. Modifications and variations are possible in light of the above teachings or may be acquired from practice of the invention.

For example, although the monitoring mode has been described in the context of commercials or other undesired programming, processor 130 may monitor the media information from first tuner 120 for any condition at which to exit monitoring and resume display/output. Such conditions may include a change in the type of media information or in the content of the media information, depending on the sophistication of the detection scheme employed by processor 130. Returning to a monitored stream of media information from another stream of media information based on any of a number of conditions is both possible and contemplated.

Also, media device 110 may include other tuners in addition to first tuner 120 and second tuner 125. For example, three or more tuners may be included in media device 110, and two or more of these may be monitored while the media information from one other tuner is output to display device 160.

Moreover, the acts in FIG. 2 need not be implemented in the order shown; nor do all of the acts necessarily need to be performed. Also, those acts that are not dependent on other acts may be performed in parallel with the other acts. Further, the acts in this figure may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Where only one item is intended, the term “one” or similar language is used. Variations and modifications may be made to the above-described implementation(s) of the claimed invention without departing substantially from the spirit and principles of the invention. All such modifications and variations are intended to be included herein within the scope of this disclosure and protected by the following claims.

1. An apparatus, comprising:
a first tuner to receive media data from a media communication link and to separate a first channel from the media data;
a second tuner to receive media data from the media communication link and to separate a second channel from the media data;
a memory to store the first channel;
a processor to selectively monitor the first channel when stored to the memory and to send one of the first channel and the second channel to a display device based on information in the first channel.

2. The apparatus of claim 1, wherein the processor is arranged to monitor the first channel for an end of commercial programming and to send the second channel to the display device until the end of commercial programming on the first channel.

3. The apparatus of claim 2, wherein the processor is further arranged to send the first channel to the display device after the end of commercial programming on the first channel.

4. The apparatus of claim 1, wherein the processor is arranged to control one of the first tuner and the second tuner in response to a controller based on the information in the first channel.

5. The apparatus of claim 4, wherein the processor is arranged to control the first tuner in response to the controller when no commercial programming exists on the first channel, and
wherein the processor is arranged to control the second tuner in response to the controller when commercial programming exists on the first channel.

6. The apparatus of claim 1, wherein the processor is arranged to send the second channel to the display device when monitoring the first channel and to send the first channel to the display device when not monitoring the first channel.

7. The apparatus of claim 1, wherein the processor is arranged to monitor the first channel for one or more of a video break, a change in resolution, a change in volume, a change in color, and an elapsed time.

8. The apparatus of claim 1, wherein the processor is arranged to monitor the first channel for two or more of a video break, a change in resolution, a change in volume, a change in color, and an elapsed time.

9. A method, comprising:
changing from outputting a first stream of media data to outputting a second stream of media data;
monitoring the first stream of media data for a predetermined condition; and
reverting to outputting the first stream of media data when the predetermined condition is detected.

10. The method of claim 9, wherein the changing is in response to a control signal from a remote controller.

11. The method of claim 9, wherein the changing is in response to a change in one or more characteristics of the first stream of media data.

12. The method of claim 9, further comprising:
storing the first stream of media data.

13. The method of claim 9, wherein the monitoring includes:
checking the first stream of media data for an interruption of the media data therein.

14. The method of claim 13, wherein the monitoring further includes:
examining the first stream of media data for one or more of a change in resolution of the media data, a change in volume of the media data, a change in color of the media data, and an elapsed time.

15. The method of claim 13, wherein the monitoring further includes:
examining the first stream of media data for two or more of a change in resolution of the media data, a change in volume of the media data, a change in color of the media data, and an elapsed time.

16. The method of claim 13, wherein the interruption of the media data includes one or more frames of media data with predetermined characteristics that are different from surrounding frames of media data.

17. The method of claim 9, wherein the monitoring includes:
checking the first stream of media data for two or more of a break in the media data, a change in resolution of the media data, a change in volume of the media data, a change in color of the media data, and an elapsed amount of time.

18. A method, comprising:
outputting a first stream of media information until a triggering event;
outputting a second stream of media information after the triggering event;
monitoring the first stream of media information for one or more characteristics that reflect a change in the first stream of media information; and
ceasing to output the second stream of media information and outputting the first stream of media information upon detection of the one or more characteristics of the first stream of media information.

19. The method of claim 18, wherein the triggering event is receipt of a control input from a controller.

20. The method of claim 18, wherein the triggering event is a beginning of a commercial in the first stream of media information.

21. The method of claim 18, wherein the one or more characteristics include a discontinuity in the media information, a change in resolution of the media information, a change in volume of the media information, a change in color of the media information, or an elapsed amount of time.

22. The method of claim 18, wherein the monitoring includes:
examining the first stream of media information for two or more characteristics that reflect the change in the first stream of media information.

23. The method of claim 18, wherein the change in the first stream of media information is an end of a commercial in the first stream of media information.

24. A machine-readable medium having instructions stored thereon, the instructions including:
instructions for displaying a second channel of video when undesirable programming is present on a first channel of video;
instructions for monitoring the first channel of video for an end of the undesirable programming; and
instructions for automatically displaying the first channel of video instead of the second channel of video when the end of the undesirable programming occurs.

25. The machine-readable medium of claim 24, further comprising:
instructions for receiving a control signal indicating that undesirable programming is present on the first channel of video.

26. The machine-readable medium of claim 24, wherein the undesirable programming includes a series of commercials.
